(19) United States
(12) Patent Application Publication
(10) Pub. No.: US 2026/0364652 A1
(43) Pub. Date: Nov. 19, 2026

(54) SEAT CLEANING SYSTEM

(71) Applicants: Hyundai Motor Company, Seoul (KR); Kia Corporation, Seoul (KR)

(72) Inventors: Baek Hee Lee, Hwaseong (KR); Yo Seob Lee, Hwaseong (KR); Sang Ji Moon, Hwaseong (KR); Won Seok Lee, Hwaseong (KR); Soong Un Choi, Hwaseong (KR); Min Hyuk Kwak, Hwaseong (KR); Kang Yen Lee, Hwaseong (KR)

(21) Appl. No.: 19/337,574

(22) Filed: Sep. 23, 2025

(30) Foreign Application Priority Data
May 14, 2025 (KR) 10-2025-0062251

(51) Int. Cl. B08B 13/00; A47L 5/38; A47L 7/00; A47L 9/12; B08B 1/14; B08B 1/30; B08B 3/02; B25J 18/00; B60N 2/90; G06V 20/59

(52) U.S. Cl. CPC B08B 13/00; A47L 5/38; A47L 7/0076; A47L 9/12; B08B 1/143; B08B 1/30; B08B 3/02; B25J 18/00; B60N 2/90; B08B 2203/0217; G06V 20/59

(57) ABSTRACT

Provided is a seat cleaning system in which an image capturing device installed inside a vehicle detects a contaminant on the surface of a seat cover, causing a cleaning robot arm arranged in a lower portion of the seat to automatically deploy to the contaminant location of the seat cover in response to a control signal from a controller, and allowing a cleaning tool mounted on a front end portion of the robot arm to automatically perform a scraper operation, a cleaning solution spraying operation, a cleaning brushing operation, and a vacuum suction operation to remove the contaminant on the seat cover, thereby allowing the contaminant on the seat cover to be automatically removed.

### CROSS-REFERENCE TO RELATED APPLICATION

The present application claims, under 35 U.S.C. §119(a), the benefit of Korean Patent Application No. 10-2025-0062251, filed May 14, 2025, the entire contents of which are incorporated herein by reference.

### BACKGROUND

### a. Technical Field

The present disclosure relates to a seat cleaning system and, more particularly, to a seat cleaning system configured to automatically remove a contaminant on a vehicle seat.

### b. Description of the Related Art

As seat color options in vehicles have diversified to meet the varying preferences of vehicle buyers, there is a growing trend toward preferring light-colored seats over dark-colored ones. However, light-colored seats do have their disadvantages. For example, when the surface of a light-colored seat is contaminated by beverages or food sauces, the extent of visible contamination on the light-colored seat tends to appear greater than that on a dark-colored seat. Additionally, when the surface of the seat, that is, the surface of the seat cover, is contaminated, failure to remove the contaminant promptly may result in the contaminant adhering to or transferring onto the seat cover, leading to discoloration of the seat cover.

When the seat of a privately owned vehicle is contaminated, contaminants on the seat cover may be removed in a timely manner using various cleaning agents and cleaning tools, but there is a drawback of requiring separate cleaning agents and cleaning tools. Furthermore, when the seat cover of a shared vehicle used by many people is contaminated, failure to promptly remove the contaminant may worsen discoloration of the seat cover as the contaminant adheres to or transfers onto the seat cover.

### SUMMARY

Various aspects of the present disclosure are directed to providing a seat cleaning system in which a camera installed inside a vehicle detects a contaminant on the surface of a seat cover, causing a cleaning robot arm arranged in a lower portion of the seat to automatically deploy to the contaminant location of the seat cover in response to a control signal from a controller, and allowing a cleaning tool mounted on a front end portion of the robot arm to automatically perform a scraper operation, a cleaning solution spraying operation, a cleaning brushing operation, and a vacuum suction operation to remove the contaminant on the seat cover, thereby allowing the contaminant on the seat cover to be automatically removed.

A seat cleaning system according to the present disclosure includes an image capturing device configured to detect a contaminant on a seat cover, a controller configured to determine a location and type of the contaminant on the seat cover based on a contaminant detection signal from the image capturing device, a storage compartment mounted in a lower portion of the seat cushion frame to move forward and rearward, a robot arm stowably mounted in the storage compartment and configured to deploy to the contaminant location on the seat cover in response to a control signal from the controller, and a cleaning tool mounted on a front end portion of the robot arm and configured to perform a scraper operation, a cleaning solution spraying operation, a cleaning brushing operation, and a vacuum suction operation on the contaminant on the seat cover in response to the control signal from the controller.

A driving device is mounted between the seat cushion frame and the storage compartment to move the storage compartment forward or backward.

The driving device includes fixed rails mounted on both sides of the seat cushion frame, rack gears formed on upper surfaces of the fixed rails, a motor mounted on a rear portion of the storage compartment and driven in response to the control signal from the controller, and a pinion connected to an output shaft of the motor and engaged with the rack gears to enable forward and rearward movement.

The robot arm includes a first motor mounted on an inner surface of the storage compartment, a pivot bar having an end portion connected to an output shaft of the first motor to enable upward and downward rotation, a second motor mounted on an opposite end portion of the pivot bar, a lower arm having an end portion connected to an output shaft of the second motor to enable left and right rotation, a third motor mounted on an opposite end portion of the lower arm, and an upper arm having an end portion mounted on an output shaft of the third motor to enable upward and downward rotation and having the cleaning tool mounted on an opposite end portion.

The cleaning tool includes a main body mounted on an opposite end portion of the upper arm, a fixed head mounted on an end portion of the main body, a variable head foldably and unfoldably connected to the fixed head, a cleaning solution spray device mounted on the fixed head, a vacuum suction device mounted on the variable head, and a brushing device mounted on the main body and configured to rotate a towel along surfaces of the fixed head and the variable head.

A deployment device is mounted on the fixed head and the variable head to be driven in response to the control signal from the controller to fold or unfold the variable head.

The deployment device includes a variable head rotation motor mounted inside the fixed head and driven in response to the control signal from the controller, a hinge shaft formed on the variable head and rotatably fastened to the fixed head, and bevel gears mounted respectively on an output shaft of the variable head rotation motor and the hinge shaft.

The cleaning solution spray device includes a cleaning solution reservoir installed inside the fixed head, a support plate positioned inside the cleaning solution reservoir, a spring mounted inside the cleaning solution reservoir to elastically support the support plate, and a plurality of pressure pins integrally formed with the support plate and arranged to protrude outward through cleaning solution discharge holes formed in the cleaning solution reservoir and cleaning solution spray holes formed in the fixed head, and a cleaning solution filling cap, arranged to protrude outward through the fixed head, is mounted on the cleaning solution reservoir.

A pressure pin of the plurality of pressure pins may be formed longer than the other pressure pins.

Accordingly, in response to a pressing force applied to the plurality of pressure pins, the plurality of pressure pins and the support plate compress the spring and move toward an inside of the cleaning solution reservoir, and accordingly, a pressure pin of the plurality of pressure pins is positioned to seal the cleaning solution discharge hole and the cleaning solution spray hole, and the other pressure pins are positioned to open the cleaning solution discharge hole and the cleaning solution spray hole.

The vacuum suction device includes a dust container mounted inside the variable head, a suction nozzle formed to extend in four directions from the dust container and fastened to a suction port formed in the variable head, a vacuum suction fan connected to the dust container via a connection pipe to provide vacuum suction power, and a filter installed inside the connection pipe. A dust removal cap, arranged to protrude outward through the variable head, is mounted on the dust container.

The brushing device includes a winding roller mounted in a first mounting groove formed on one side of the main body, a collecting roller mounted in a second mounting groove formed on an opposite side of the main body, the towel having an end portion wound on the winding roller and an opposite end portion connected to the collecting roller, and configured to rotate along the surfaces of the fixed head and the variable head, a driven gear mounted on a rotation shaft of the collecting roller, a towel rotation motor mounted inside the main body, and a driving gear mounted on an output shaft of the towel rotation motor and engaged with the driven gear.

The controller is configured to set an absolute coordinate system based on a reference point on an upper portion of a seatback and a reference point on a front portion of a seat cushion captured by the image capturing device, and to determine a location of the contaminant on the seat cover using the set absolute coordinate system.

In addition, the controller is configured to determine the type of contaminant on the seat cover as one of a liquid, a non-Newtonian fluid, or a solid based on the contaminant detection signal from the image capturing device.

In addition, based on the determined type of contaminant, the controller is configured to determine chrominance of the contaminant and size information of the contaminant that changes over a certain period based on the contaminant detection signal transmitted from the image capturing device, and to selectively operate at least one of a cleaning solution spray device, a vacuum suction device, or a brushing device based on the determined chrominance and size information of the contaminant.

In addition, the controller is configured to selectively operate at least one of the cleaning solution spray device, the vacuum suction device, or the brushing device under conditions in which the vehicle is turned off and a passenger exits the vehicle.

A signal satisfying the passenger exit condition may be provided from a seat belt reminder to the controller.

Through the above-described solution, the present disclosure provides the following effects.

First, when a camera installed inside the vehicle detects a contaminant on the surface of the seat cover, the robot arm is automatically deployed to the contaminant location on the seat cover, and the cleaning tool mounted at the front end portion of the robot arm performs a scraper operation, a cleaning solution spraying operation, a cleaning brushing operation, and a vacuum suction operation to automatically remove the contaminant on the seat cover.

Second, depending on the type of contaminant on the surface of the seat cover (e.g., liquid, non-Newtonian fluid, solid), the scraper operation to scrape and remove the contaminant, the cleaning solution spraying and cleaning brushing operations in which a cleaning solution is sprayed onto the contaminant and wiped off using a towel, and the vacuum suction operation for the contaminant are selectively performed, thereby enabling easy removal of any contaminant on the seat cover surface.

According to an aspect of the present disclosure, a seat cleaning system is provided. The cleaning system may comprise an image capturing device configured to detect a contaminant on a seat cover, a controller configured to determine a contaminant location and type of the contaminant on the seat cover based on a contaminant detection signal from the image capturing device, a robot arm configured to deploy to the contaminant location on the seat cover in response to a control signal from the controller, and a cleaning tool mounted on a front end portion of the robot arm, the cleaning tool being configured, in response to the control signal, to perform one or more of, on the contaminant, a scraper operation, a cleaning solution spraying operation, a cleaning brushing operation, and a vacuum suction operation.

According to an exemplary embodiment, the robot arm may be stowably mounted in a lower position of the seat cushion frame in a storage compartment configured to move forward and rearward, and a driving device may be mounted between the seat cushion frame and the storage compartment and configured to move the storage compartment forward or rearward.

According to an exemplary embodiment, the driving device may comprise fixed rails mounted on both sides of the seat cushion frame, rack gears formed on upper surfaces of the fixed rails, a storage compartment motor mounted on a rear portion of the storage compartment, configured to be driven in response to the control signal from the controller, and a pinion coupled to an output shaft of the motor and engaged with the rack gears to enable forward and rearward movement.

According to an exemplary embodiment, the robot arm may comprise a first motor mounted on an inner surface of a storage compartment, a pivot bar comprising an end portion coupled to an output shaft of the first motor to enable upward and downward rotation, a second motor mounted on an opposite end portion of the pivot bar, a lower arm comprising an end portion connected to an output shaft of the second motor to enable left and right rotation, a third motor mounted on an opposite end portion of the lower arm, and an upper arm comprising an end portion mounted on an output shaft of the third motor to enable upward and downward rotation and the cleaning tool mounted on an opposite end portion.

According to an exemplary embodiment, the cleaning tool may comprise a main body mounted on an opposite end portion of the upper arm, a fixed head mounted on an end portion of the main body, a variable head foldably and unfoldably connected to the fixed head, a cleaning solution spray device mounted on the fixed head, a vacuum suction device mounted on the variable head, and a brushing device mounted on the main body and configured to rotate a towel along surfaces of the fixed head and the variable head.

According to an exemplary embodiment, the seat cleaning system may comprise a deployment device mounted on the fixed head and the variable head to be driven in response to the control signal from the controller to fold or unfold the variable head.

According to an exemplary embodiment, the deployment device may comprise a variable head rotation motor mounted inside the fixed head and driven in response to the control signal from the controller, a hinge shaft formed on the variable head and rotatably fastened to the fixed head, and bevel gears mounted respectively on an output shaft of the variable head rotation motor and the hinge shaft.

According to an exemplary embodiment, the cleaning solution spray device may comprise a cleaning solution reservoir installed inside the fixed head, a support plate positioned inside the cleaning solution reservoir, a spring mounted inside the cleaning solution reservoir to elastically support the support plate, and a plurality of pressure pins integrally formed with the support plate and arranged to protrude outward through cleaning solution discharge holes formed in the cleaning solution reservoir and cleaning solution spray holes formed in the fixed head.

According to an exemplary embodiment, a pressure pin of the plurality of pressure pins may be formed longer than the other pressure pins.

According to an exemplary embodiment, in response to a pressing force applied to the plurality of pressure pins, the plurality of pressure pins and the support plate may be configured to compress the spring and move toward an inside of the cleaning solution reservoir.

According to an exemplary embodiment, a pressure pin of the plurality of pressure pins may be positioned to seal the cleaning solution discharge hole and the cleaning solution spray hole.

According to an exemplary embodiment, other pressure pins, of the plurality of pressure pins, may be positioned to open the cleaning solution discharge hole and the cleaning solution spray hole.

According to an exemplary embodiment, the seat cleaning system may comprise a cleaning solution filling cap, arranged to protrude outward through the fixed head, mounted on the cleaning solution reservoir.

According to an exemplary embodiment, the vacuum suction device may comprise a dust container mounted inside the variable head, a suction nozzle formed to extend in four directions from the dust container and fastened to a suction port formed in the variable head, a vacuum suction fan coupled to the dust container via a connection pipe to provide vacuum suction power, and a filter installed inside the connection pipe.

According to an exemplary embodiment, the brushing device may comprise a winding roller mounted in a first mounting groove formed on a side of the main body, a collecting roller mounted in a second mounting groove formed on an opposite side of the main body, and a towel comprising an end portion wound on the winding roller and an opposite end portion connected to the collecting roller, the towel configured to rotate along the surfaces of the fixed head and the variable head.

According to an exemplary embodiment, the brushing device may comprise a driven gear mounted on a rotation shaft of the collecting roller, a towel rotation motor mounted inside the main body, and a driving gear mounted on an output shaft of the towel rotation motor and engaged with the driven gear.

According to an exemplary embodiment, the controller may be configured to set an absolute coordinate system based on a reference point on an upper portion of a seatback and a reference point on a front portion of a seat cushion captured by the image capturing device, and determine a location of the contaminant on the seat cover using the set absolute coordinate system.

According to an exemplary embodiment, the controller may be configured to determine the type of contaminant on the seat cover as one of a liquid, a non-Newtonian fluid, or a solid based on the contaminant detection signal from the image capturing device.

According to an exemplary embodiment, based on the determined type of contaminant, the controller may be configured to determine chrominance of the contaminant and size information of the contaminant that changes over a certain period based on the contaminant detection signal transmitted from the image capturing device, and selectively operate at least one of a cleaning solution spray device, a vacuum suction device, or a brushing device based on the determined chrominance and size information of the contaminant.

According to an exemplary embodiment, the controller may be configured to selectively operate at least one of the cleaning solution spray device, the vacuum suction device, or the brushing device under conditions in which the vehicle is turned off and a passenger exits the vehicle.

According to an exemplary embodiment, a signal satisfying the passenger exit condition may be provided from a seat belt reminder to the controller.

According to an aspect of the present disclosure, a seat cleaning system is provided. The seat cleaning system may comprise a computing device comprising a processor and a memory. The memory may be configured to store instructions that, when executed by the processor, are configured to cause the processor to detect a contaminant on a seat cover, using an image capturing device, determine a contaminant location and type of the contaminant on the seat cover based on a contaminant detection signal from the image capturing device, deploy a robot arm to the contaminant location on the seat cover in response to a control signal from a controller, and, using a cleaning tool mounted on a front end portion of the robot arm, in response to the control signal, perform one or more of, on the contaminant, a scraper operation, a cleaning solution spraying operation, a cleaning brushing operation, and a vacuum suction operation.

### BRIEF DESCRIPTION OF THE DRAWINGS

The foregoing and other aspects, features, and advantages, as well as the following detailed description of the embodiments, will be better understood when read in conjunction with the accompanying drawings. However, the present disclosure is not intended to be limited to the details shown in the drawings, and various modifications and structural changes may be made therein without departing from the spirit of the present disclosure and within the scope and range of equivalents of the claims. Like reference numbers and designations in the various drawings indicate like elements.

FIGS. 1 and 2 illustrate external perspective views showing a state in which a seat cleaning system is installed on a seat, according to an exemplary embodiment of the present disclosure.

FIGS. 3 and 4 illustrate perspective views showing a deployed state and a stored state of a robot arm of the seat cleaning system, according to an exemplary embodiment of the present disclosure.

FIG. 5 illustrates a schematic view showing a driving device for moving a storage compartment forward and rearward in a configuration of the seat cleaning system, according to an exemplary embodiment of the present disclosure.

FIG. 6 illustrates a schematic view showing a brushing device mounted on a main body in a configuration of the seat cleaning system, according to an exemplary embodiment of the present disclosure.

FIG. 7 illustrates a schematic view showing a collecting roller driving device of the brushing device in a configuration of the seat cleaning system, according to an exemplary embodiment of the present disclosure.

FIG. 8 illustrates a schematic view showing a cleaning tool of the seat cleaning system, according to an exemplary embodiment of the present disclosure.

FIG. 9 illustrates a cross-sectional view showing a configuration of a cleaning solution spray device mounted inside a fixed head and a vacuum suction device mounted inside a variable head of the cleaning tool of the seat cleaning system, according to an exemplary embodiment of the present disclosure.

FIG. 10 illustrates a cross-sectional view showing a cleaning solution spray device installed inside a fixed head of the seat cleaning system, according to an exemplary embodiment of the present disclosure.

FIG. 11 illustrates a schematic view showing a state in which a towel for brushing is wound around the cleaning tool of the seat cleaning system, according to an exemplary embodiment of the present disclosure.

FIGS. 12, 13, and 14 illustrate schematic views showing an operation in which a contaminant on a seat cover is removed by the cleaning tool of the seat cleaning system, according to an exemplary embodiment of the present disclosure.

FIG. 15 illustrates a control configuration diagram of the seat cleaning system, according to an exemplary embodiment of the present disclosure.

FIG. 16 illustrates example elements of a computing device, according to an exemplary embodiment of the present disclosure.

### DETAILED DESCRIPTION

The specific structural or functional descriptions provided in embodiments of the present specification are merely illustrative, intended to describe the embodiments according to the concept of the present disclosure. The embodiments according to the concept of the present disclosure may be implemented in various forms, and the present disclosure should not be interpreted as limited by the embodiments described in the present specification, but should be understood to include all modifications, equivalents, or substitutes within the spirit and technical scope of the present disclosure.

Terms such as first and/or second used in the present specification may be used to describe various components, but the components are not limited by these terms. The terms are used solely for distinguishing one component from another component. For example, without departing from the scope of the present disclosure according to the concept of the present disclosure, a first component may be referred to as a second component, and similarly, the second component may also be referred to as the first component.

When a component is referred to as being “connected” or “coupled” to another component, the component may be directly connected or coupled to another component, but it should be understood that sill another component may be present between the component and another component. Conversely, when a component is referred to as being “directly connected” or “directly coupled” to another component, it should be understood that still another component may not be present between the component and another component. Other expressions, that is, "between" and "just between" or "adjacent to" and "directly adjacent to", for describing a relationship between components, should be interpreted in a similar manner.

Like reference numerals indicate like components throughout the present specification. Terms used in the present specification are used for describing embodiments, not limiting the present disclosure. Unless particularly stated otherwise in the present specification, a singular form also includes a plural form. The terms “comprises” and/or “comprising” used in the specification are merely intended to indicate that components, steps, operations, and/or elements described below are present, and do not exclude the presence or addition of one or more other components, steps, operations, and/or elements.

The following Detailed Description is merely provided by way of example and not of limitation. Furthermore, there is no intention to be bound by any expressed or implied theory presented in the preceding background or in the following Detailed Description.

Reference will now be made in detail to various exemplary embodiments of the subject matter, examples of which are illustrated in the accompanying drawings. While various embodiments are discussed herein, it will be understood that they are not intended to limit to these embodiments. On the contrary, the presented embodiments are intended to cover alternatives, modifications, and equivalents, which may be included within the spirit and scope of the various embodiments as defined by the appended claims. Furthermore, in this Detailed Description, numerous specific details are set forth in order to provide a thorough understanding of embodiments of the present subject matter. However, embodiments may be practiced without these specific details. In other instances, well known methods, procedures, components, and circuits have not been described in detail as not to unnecessarily obscure aspects of the described embodiments.

Some portions of the detailed descriptions which follow are presented in terms of procedures, logic blocks, processing, and other symbolic representations of operations on data within an electrical device. These descriptions and representations are the means used by those skilled in the data processing arts to most effectively convey the substance of their work to others skilled in the art. In the present application, a procedure, logic block, process, or the like, is conceived to be one or more self-consistent procedures or instructions leading to a desired result. The procedures are those requiring physical manipulations of physical quantities. Usually, although not necessarily, these quantities may take the form of electrical or magnetic signals capable of being stored, transferred, combined, compared, and otherwise manipulated in an electronic system, device, and/or component.

It should be borne in mind, however, that these and similar terms are to be associated with the appropriate physical quantities and are merely convenient labels applied to these quantities. Unless specifically stated otherwise as apparent from the following discussions, it is appreciated that throughout the description of embodiments, discussions utilizing terms such as “determining,” “communicating,” “taking,” “comparing,” “monitoring,” “calibrating,” “estimating,” “initiating,” “providing,” “receiving,” “controlling,” “transmitting,” “isolating,” “generating,” “aligning,” “synchronizing,” “identifying,” “maintaining,” “displaying,” “switching,” or the like, refer to the actions and processes of an electronic item such as: a processor, a sensor processing unit (SPU), a processor of a sensor processing unit, an application processor of an electronic device/system, or the like, or a combination thereof. The item manipulates and transforms data represented as physical (electronic and/or magnetic) quantities within the registers and memories into other data similarly represented as physical quantities within memories or registers or other such information storage, transmission, processing, or display components.

It is understood that the term "vehicle" or "vehicular" or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles. In aspects, a vehicle may comprise an internal combustion engine system as disclosed herein.

The terminology used herein is for the purpose of describing particular embodiments only and is not intended to be limiting of the disclosure. As used herein, the singular forms "a," "an" and "the" are intended to include the plural forms as well, unless the context clearly indicates otherwise. These terms are merely intended to distinguish one component from another component, and the terms do not limit the nature, sequence or order of the constituent components. It will be further understood that the terms "comprises" and/or "comprising," when used in this specification, specify the presence of stated features, integers, steps, operations, elements, and/or components, but do not preclude the presence or addition of one or more other features, integers, steps, operations, elements, components, and/or groups thereof. As used herein, the term "and/or" includes any and all combinations of one or more of the associated listed items. Throughout the specification, unless explicitly described to the contrary, the word “comprise” and variations such as “comprises” or “comprising” will be understood to imply the inclusion of stated elements but not the exclusion of any other elements. In addition, the terms “unit”, “-er”, “-or”, and “module” described in the specification mean units for processing at least one function and operation, and can be implemented by hardware components or software components and combinations thereof.

Although exemplary embodiment is described as using a plurality of units to perform the exemplary process, it is understood that the exemplary processes may also be performed by one or plurality of modules. Additionally, it is understood that the term controller/control unit refers to a hardware device that includes a memory and a processor and is specifically programmed to execute the processes described herein. The memory is configured to store the modules and the processor is specifically configured to execute said modules to perform one or more processes which are described further below.

Further, the control logic of the present disclosure may be embodied as non-transitory computer readable media on a computer readable medium containing executable program instructions executed by a processor, controller or the like. Examples of computer readable media include, but are not limited to, ROM, RAM, compact disc (CD)-ROMs, magnetic tapes, floppy disks, flash drives, smart cards and optical data storage devices. The computer readable medium can also be distributed in network coupled computer systems so that the computer readable media is stored and executed in a distributed fashion, e.g., by a telematics server or a Controller Area Network (CAN).

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about”.

Embodiments described herein may be discussed in the general context of processor-executable instructions residing on some form of non-transitory processor-readable medium, such as program modules, executed by one or more computers or other devices. Generally, program modules include routines, programs, objects, components, data structures, etc., that perform particular tasks or implement particular abstract data types. The functionality of the program modules may be combined or distributed as desired in various embodiments.

In the figures, a single block may be described as performing a function or functions; however, in actual practice, the function or functions performed by that block may be performed in a single component or across multiple components, and/or may be performed using hardware, using software, or using a combination of hardware and software. To clearly illustrate this interchangeability of hardware and software, various illustrative components, blocks, modules, logic, circuits, and steps have been described generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Also, the example device vibration sensing system and/or electronic device described herein may include components other than those shown, including well-known components.

Various techniques described herein may be implemented in hardware, software, firmware, or any combination thereof, unless specifically described as being implemented in a specific manner. Any features described as modules or components may also be implemented together in an integrated logic device or separately as discrete but interoperable logic devices. If implemented in software, the techniques may be realized at least in part by a non-transitory processor-readable storage medium comprising instructions that, when executed, perform one or more of the methods described herein. The non-transitory processor-readable data storage medium may form part of a computer program product, which may include packaging materials.

The non-transitory processor-readable storage medium may comprise random access memory (RAM) such as synchronous dynamic random access memory (SDRAM), read only memory (ROM), non-volatile random access memory (NVRAM), electrically erasable programmable read-only memory (EEPROM), FLASH memory, other known storage media, and the like. The techniques additionally, or alternatively, may be realized at least in part by a processor-readable communication medium that carries or communicates code in the form of instructions or data structures and that can be accessed, read, and/or executed by a computer or other processor.

Various embodiments described herein may be executed by one or more processors, such as one or more motion processing units (MPUs), sensor processing units (SPUs), host processor(s) or core(s) thereof, digital signal processors (DSPs), general purpose microprocessors, application specific integrated circuits (ASICs), application specific instruction set processors (ASIPs), field programmable gate arrays (FPGAs), a programmable logic controller (PLC), a complex programmable logic device (CPLD), a discrete gate or transistor logic, discrete hardware components, or any combination thereof designed to perform the functions described herein, or other equivalent integrated or discrete logic circuitry. The term “processor,” as used herein may refer to any of the foregoing structures or any other structure suitable for implementation of the techniques described herein. As employed in the subject specification, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory. Moreover, processors can exploit nano-scale architectures such as, but not limited to, molecular and quantum-dot based transistors, switches and gates, in order to optimize space usage or enhance performance of user equipment. A processor may also be implemented as a combination of computing processing units.

In addition, in some aspects, the functionality described herein may be provided within dedicated software modules or hardware modules configured as described herein. Also, the techniques could be fully implemented in one or more circuits or logic elements. A general purpose processor may be a microprocessor, but in the alternative, the processor may be any processor, controller, microcontroller, or state machine. A processor may also be implemented as a combination of computing devices, e.g., a combination of an SPU/MPU and a microprocessor, a plurality of microprocessors, one or more microprocessors in conjunction with an SPU core, MPU core, or any other such configuration. One or more components of an SPU or electronic device described herein may be embodied in the form of one or more of a “chip,” a “package,” an Integrated Circuit (IC).

Various exemplary embodiments of the present disclosure will be described in detail below with reference to the accompanying drawings.

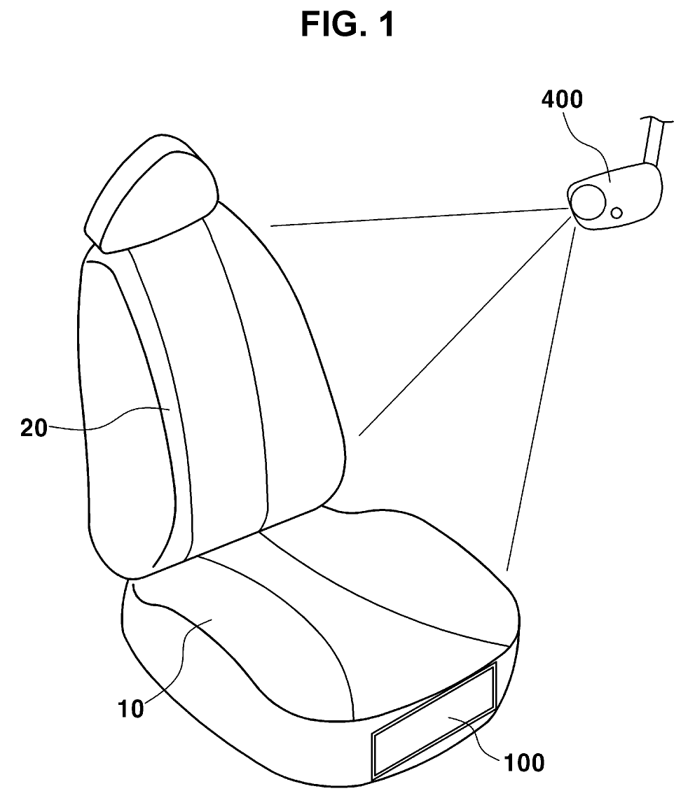

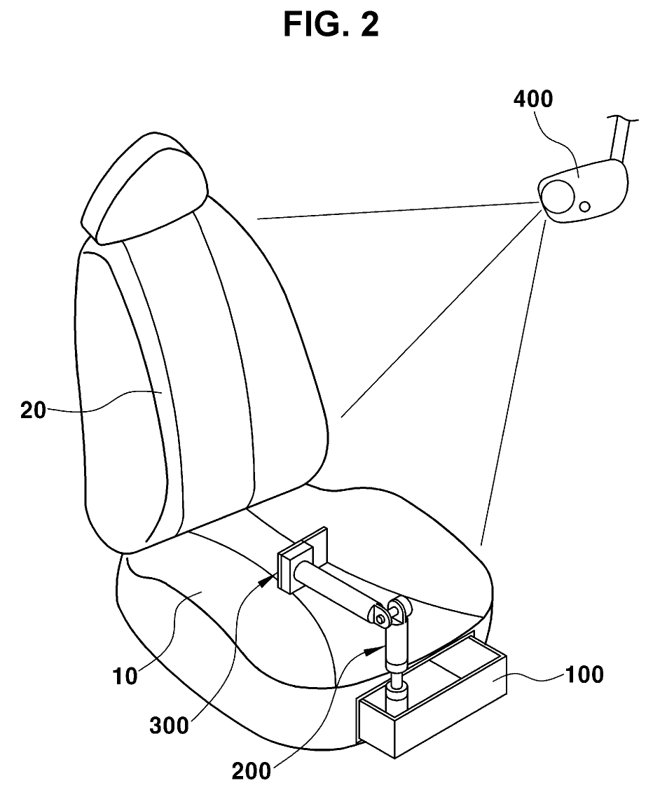

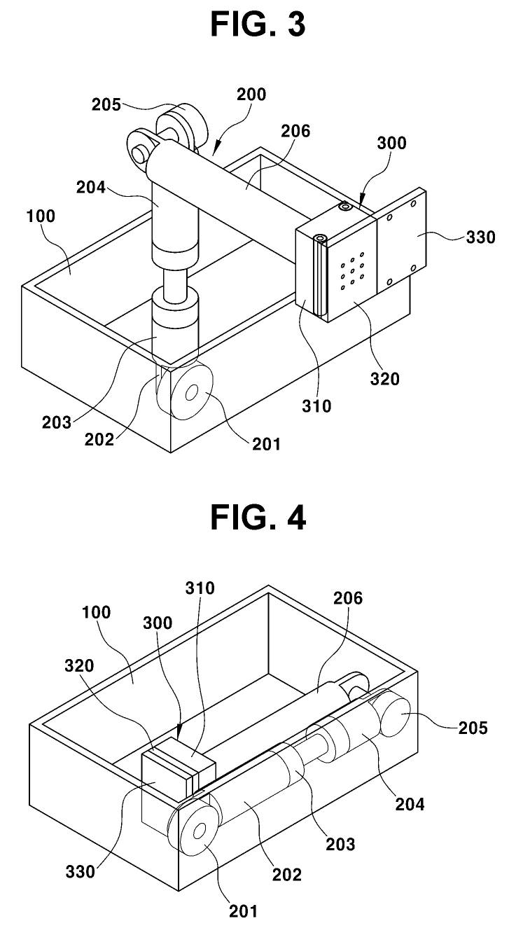

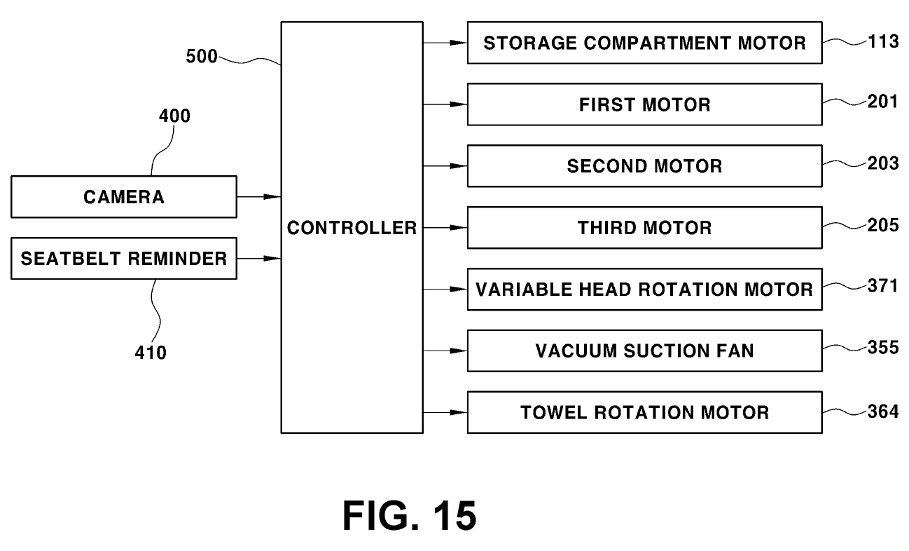

Referring to FIGS. 1 and 2, external perspective views showing a state in which a seat cleaning system is installed on a seat are illustratively depicted, in accordance with an exemplary embodiment of the present disclosure. Referring to FIGS. 3 and 4, perspective views showing a deployed state and a stored state of a robot arm of the seat cleaning system are illustratively depicted in accordance with an exemplary embodiment of the present disclosure. Referring to FIG. 15, a control configuration diagram of the seat cleaning system is illustratively depicted, in accordance with an exemplary embodiment of the present disclosure.

As shown in FIGS. 1 and 2, a vehicle seat is depicted comprising a seat cushion 10 and a seatback 20. The vehicle seat comprise a storage compartment 100, housed in a lower portion of the seat cushion 10, configured to accommodate components for cleaning a contaminant on a seat cover. The vehicle seat may be arranged to enable forward and rearward movement of the storage compartment 100.

According to an exemplary embodiment, at a predetermined position inside the vehicle, a camera 400 may be provided. The camera 400 may be equipped with an image sensor configured to act as an image capturing device for detecting a contaminant on the seat cover. The camera 400 may be configured to capture the contaminant on the seat cover of the vehicle seat and transmit a detection signal to a controller 500.

According to an exemplary embodiment a driving device 110 configured to move the storage compartment 100 forward or rearward may be mounted between a seat cushion frame 11 and the storage compartment 100 to enable forward and rearward movement of the storage compartment 100.

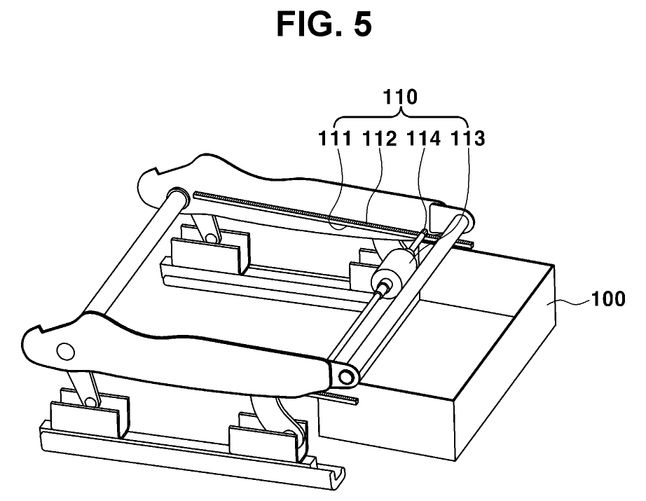

As shown in FIG. 5, the driving device 110 may comprise fixed rails 111 mounted on both sides of the seat cushion frame 11, rack gears 112 formed on the upper surfaces of the fixed rails 111, a storage compartment motor 113 mounted on a rear portion of the storage compartment 100 and driven in response to a control signal from the controller 500, and a pinion 114 connected to an output shaft of the motor 113 and engaged with the rack gears 112 to enable forward and rearward movement.

Accordingly, the motor 113 may be configured to be driven in one direction, causing the pinion 114 to move forward along the rack gear 112 of the fixed rail 111, thereby moving the storage compartment 100 toward the front of the seat cushion 10. Conversely, the motor 113 may be configured to be driven in the opposite direction, causing the pinion 114 to move rearward along the rack gear 112 of the fixed rail 111, thereby moving the storage compartment 100 to a lower portion of the seat cushion 10 for storage.

In addition to a rack and pinion method, various other mechanisms such as, e.g., an electric cylinder, lead screw, or linear motor may be incorporated as the driving device 110 for moving the storage compartment 100 forward or rearward.

According to an exemplary embodiment, a robot arm 200 may be stowably mounted in the storage compartment 100 and configured to deploy toward the contaminant location on the seat cover in response to the control signal from the controller 500.

To this end, as shown in FIGS. 3 and 4, the robot arm 200 may comprise a first motor 201 mounted on an inner surface of the storage compartment 100, a pivot bar 202 comprising an end portion coupled to an output shaft of the first motor 201 to enable upward and downward rotation, a second motor 203 mounted on an opposite end portion of the pivot bar 202, a lower arm 204 comprising an end portion coupled to an output shaft of the second motor 203 to enable left and right rotation, a third motor 205 mounted on the opposite end portion of the lower arm 204, and an upper arm 206 comprising an end portion connected to an output shaft of the third motor 205 to enable upward and downward rotation and having a cleaning tool 300 mounted on the opposite end portion.

Accordingly, by driving the first motor 201 in one direction, the pivot bar 202 and the lower arm 204 may be rotated upward, and by driving the third motor 205 in one direction, the upper arm 206 may be rotated upward, so that the robot arm 200 may be deployed outward from the storage compartment 100, as shown, e.g., in FIG. 3. In addition, by driving the second motor 203 in one or the opposite direction, the lower arm 204 and the upper arm 206 may be configured to rotate in the left or right direction.

On the other hand, by driving the first motor 201 in the opposite direction, the pivot bar 202 and the lower arm 204 may be rotated downward, and by driving the third motor 205 in the opposite direction, the upper arm 206 may be rotated downward, so that the robot arm 200 may be stored inside the storage compartment 100, as shown, e.g., in FIG. 4.

In addition to the pivot bar 202, the lower arm 204, and the upper arm 206, the robot arm 200 may comprise an additional arm further coupled to the upper arm 206, which may be configured to be rotated by a motor. Accordingly, the cleaning tool 300 mounted on the additional arm may be configured to easily access an entire surface of the seatback and seat cushion.

According to an exemplary embodiment of the present disclosure, the cleaning tool 300 may be mounted on the opposite end portion of the upper arm 206 of the robot arm 200 and may be configured to perform a scraper operation, a cleaning solution spraying operation, a cleaning brushing operation, and/or a vacuum suction operation on the contaminant on the seat cover in response to a control signal from the controller 500.

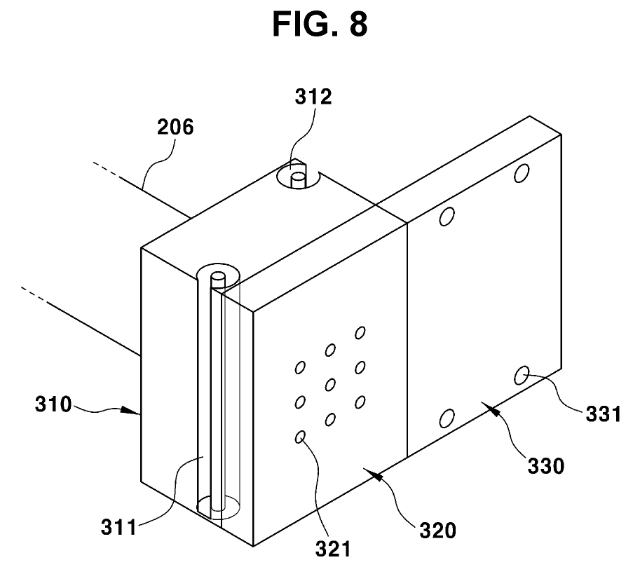

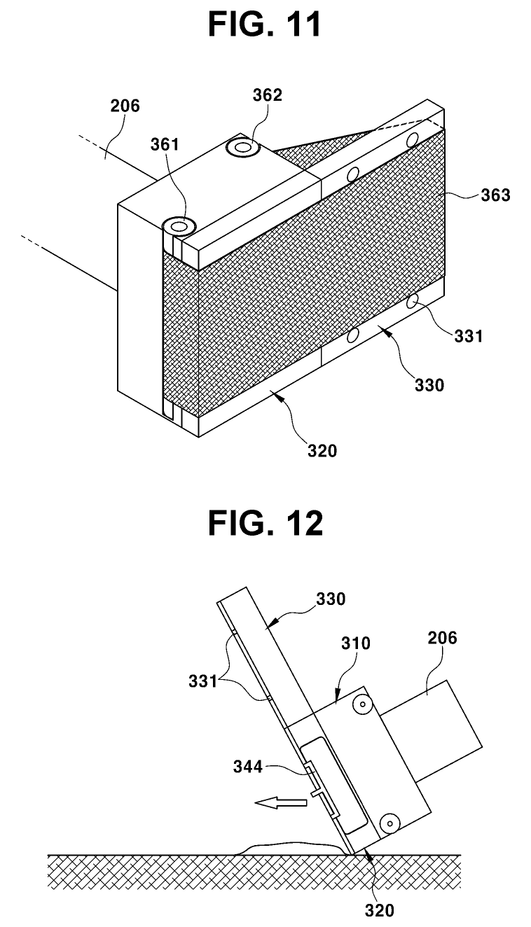

To this end, as shown in FIGS. 8 and 11, the cleaning tool 300 may comprise a housing-type main body 310 mounted on the opposite end portion of the upper arm 206 of the robot arm 200, a case-type fixed head 320 mounted on an end portion of the main body 310, a case-type variable head 330 foldably and unfoldably connected to the fixed head 320, a cleaning solution spray device 340 mounted on the fixed head 320 to discharge cleaning solution toward the contaminant on the seat cover, a vacuum suction device 350 mounted on the variable head 330 to perform vacuum suction of the contaminant adhering to or removed from the seat cover, and/or a brushing device 360 mounted on the main body 310 and configured to rotate a towel 363 along the surfaces of the fixed head 320 and the variable head 330 to wipe off contaminants or residues on the seat cover.

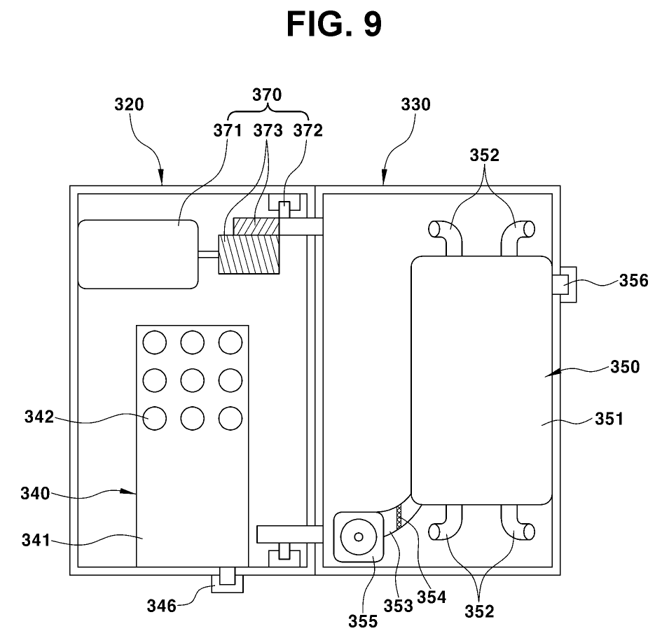

According to an exemplary embodiment, a deployment device 370 may be mounted on the fixed head 320 and the variable head 330, which may be configured to be driven in response to the control signal from the controller 500 to fold or unfold the variable head 330 relative to the fixed head 320. To this end, as shown, e.g., in FIG. 9, the deployment device 370 may comprise a variable head rotation motor 371 mounted inside the fixed head 320 and configured to be driven in response to the control signal from the controller 500, a hinge shaft 372 formed on the variable head 330 and rotatably fastened to the fixed head 320, and bevel gears 373 mounted respectively on an output shaft of the variable head rotation motor 371 and the hinge shaft 372.

In response to driving the variable head rotation motor 371 in one direction, the motor torque may be transmitted to the hinge shaft 372 through the bevel gears 373, allowing the variable head 330 to fold toward the fixed head 320. Conversely, in response to driving the variable head rotation motor 371 in the opposite direction, the motor torque may be transmitted through the bevel gears 373 to the hinge shaft 372, allowing the variable head 330 to unfold to a position coplanar with the fixed head 320.

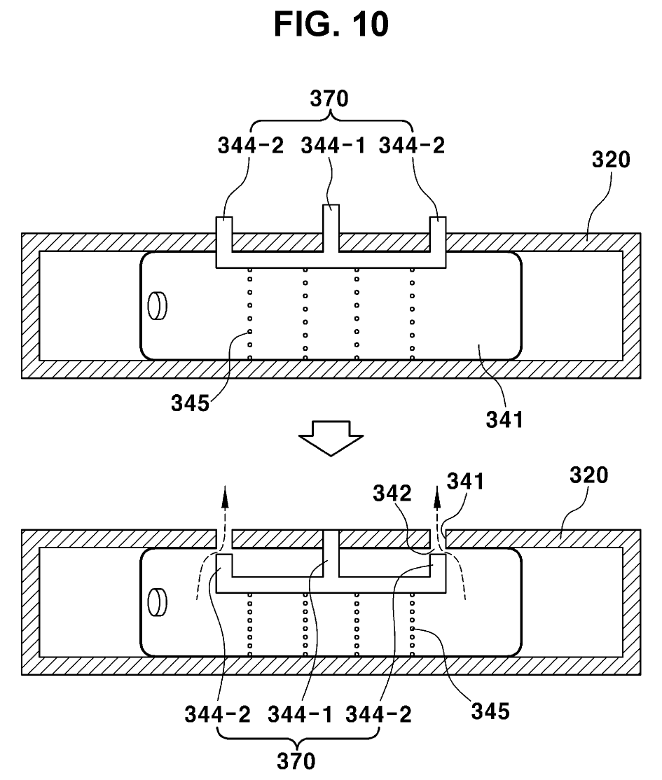

As shown in FIGS. 9 and 10, the cleaning solution spray device 340 may comprise a cleaning solution reservoir 341 installed inside the fixed head 320 and having a structure with multiple cleaning solution discharge holes 342, a support plate 343 positioned inside the cleaning solution reservoir 341, a spring 345 mounted inside the cleaning solution reservoir 341 to elastically support the support plate 343, and a plurality of pressure pins 344 integrally formed with the support plate 343 and arranged to protrude outward through the cleaning solution discharge holes 342 of the cleaning solution reservoir 341 and cleaning solution spray holes 321 formed in the fixed head 320.

A cleaning solution filling cap 346, arranged to protrude outward through the fixed head 320, may be mounted on the cleaning solution reservoir 341, and the cleaning solution may be filled into the cleaning solution reservoir 341 by opening this cleaning solution filling cap 346.

In particular, as shown in FIG. 10, one pressure pin 344-1 of the plurality of pressure pins 344 may be formed longer than the other pressure pins 344-2, so that the cleaning solution inside the cleaning solution reservoir 341 may be easily discharged to the outside through the cleaning solution discharge hole 342 and the cleaning solution spray hole 321.

Accordingly, in response to a pressing force applied to the plurality of pressure pins 344, the plurality of pressure pins 344 may be configured to move rearward, and the support plate 343, integrally formed with the pressure pins 344, may be configured to compress the spring 345 and move rearward into the cleaning solution reservoir 341.

In addition, in response to the plurality of pressure pins 344 moving rearward into the cleaning solution reservoir 341, as shown in FIG. 10, one pressure pin 344-1 of the plurality of pressure pins 344 may be positioned to seal the cleaning solution discharge hole 342 and cleaning solution spray holes 321, and the other pressure pins 344-2 may be positioned to open the cleaning solution discharge hole 342 and cleaning solution spray hole 321, thereby allowing the cleaning solution inside the cleaning solution reservoir 341 to be discharged to the outside through the opened cleaning solution discharge hole 342 and cleaning solution spray hole 321.

As shown in FIG. 9, the vacuum suction device 350 may comprise a dust container 351 mounted inside the variable head 330, a suction nozzle 352 formed to extend in four directions from the dust container 351 and fastened to a suction port 331 formed in the variable head 330, a vacuum suction fan 355 connected to the dust container 351 via a connection pipe 353 to provide vacuum suction power, and a filter 354 installed inside the connection pipe 353.

The dust container 351 may be equipped with a dust removal cap 356 protruding externally through the variable head 330, allowing the dust removal cap 356 to be opened for discharging dust collected inside the dust container 351.

In addition, the fixed head 320 may be configured to be detachably mounted on the main body 310 of the cleaning tool 300 using a separate clamping mechanism, so that the fixed head 320 and the variable head 330 may be easily separated from the main body 310.

Accordingly, the cleaning solution filling cap 346 may be configured to be opened to easily fill cleaning solution into the cleaning solution reservoir 341 positioned inside the separated fixed head 320, and the dust removal cap 356 may be configured to be opened to easily discharge the collected dust from the dust container 351 positioned inside the separated variable head 330 to the outside.

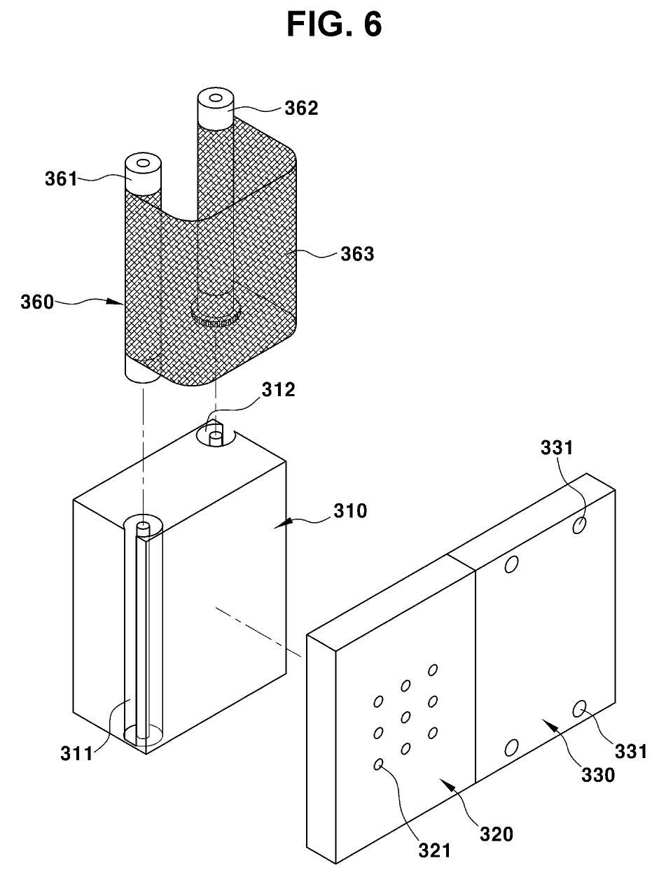

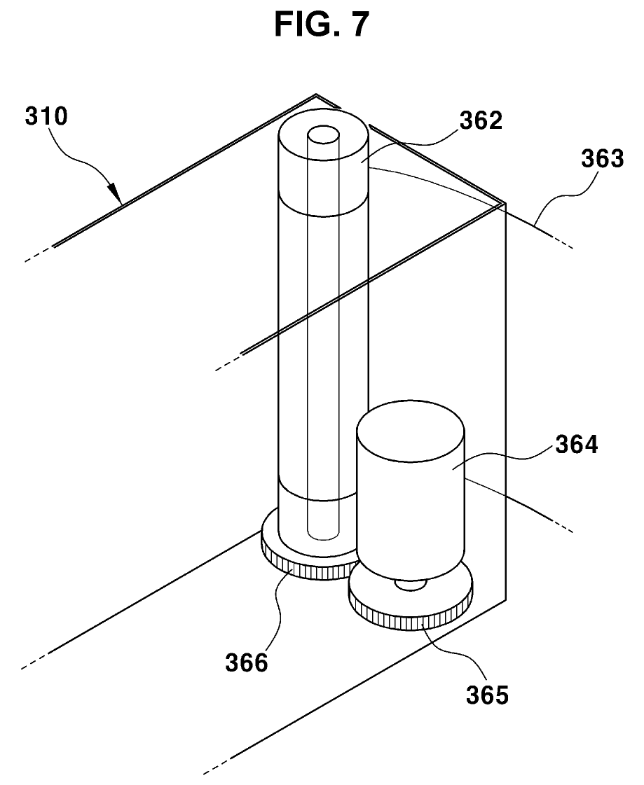

As shown in FIGS. 6 and 7, the brushing device 360 may comprise a winding roller 361 mounted in a first mounting groove 311 formed on one side of the main body 310, a collecting roller 362 mounted in a second mounting groove 312 formed on the opposite side of the main body 310, and the towel 363 having an end portion wound on the winding roller 361 and the opposite end portion connected to the collecting roller 362, and configured to rotate along the surfaces of the fixed head 320 and the variable head 330.

In addition, the brushing device 360 may comprise a driven gear 366 mounted on a rotation shaft of the collecting roller 362 to enable movement of the towel 363, a towel rotation motor 364 mounted inside the main body 310, and a driving gear 365 mounted on an output shaft of the towel rotation motor 364 and engaged with the driven gear 366.

Accordingly, in response to the driving of the towel rotation motor 364, the driving gear 365 may be configured to rotate in one direction, and the driven gear 366, engaged with the driving gear 365, may be configured to rotate, allowing the collecting roller 362 to rotate. As a result, an uncontaminated area of the towel 363 may be drawn out from the winding roller 361, and a contaminated area of the towel 363 may be wound onto the collecting roller 362 for collection.

In addition, the controller 500 may be configured to receive a detection signal from the camera 400, capturing a contaminant on the seat cover of the vehicle seat, and may be configured to determine the location and type of the contaminant on the seat cover based on the received contaminant detection signal.

To this end, the controller 500 may be configured to set an absolute coordinate system based on a reference point on an upper portion of the seatback and a reference point on a front portion of the seat cushion captured by the camera 400, and may be configured to determine the location of the contaminant on the seat cover using the set absolute coordinate system.

In addition, the controller 500 may be configured to determine the type of contaminant on the seat cover as one of a liquid (milk, juice, coffee, etc.), a non-Newtonian fluid (ketchup, mayonnaise, toothpaste, etc.), or a solid (soil, salt, sugar, snack crumbs, etc.) based on a contaminant detection signal from the camera 400 and pre-trained data through artificial intelligence deep learning image analysis.

In addition, after determining the type of contaminant, the controller 500 may be configured to determine the chrominance of the contaminant and the size information of the contaminant that changes over a certain period based on the contaminant detection signal transmitted from the camera 400, and to selectively operate at least one of the cleaning solution spray device 340, the vacuum suction device 350, or the brushing device 360 based on the determined chrominance and size information of the contaminant.

For example, the controller 500 may be configured to determine the chrominance (ΔE) of the contaminant using the chrominance formula defined by the Commission International de Eclairage (CIE) (which represents the chrominance as a numerical value by calculating the three-dimensional distance between two objects with different colors), and if the chrominance (ΔE) ≥ 0.5, the controller 500 may be configured to selectively operate at least one of the above-described cleaning solution spray device 340, the vacuum suction device 350, or the brushing device 360.

In addition, the controller 500 may be configured to determine that the contaminant is a certain amount or more of a non-Newtonian fluid (ketchup, mayonnaise, toothpaste, etc.) if the size of the contaminant increases over a certain period of time, and may be configured to control the movement of the robot arm, so that a scraper operation may be performed by an edge portion of the fixed head 320 of the cleaning tool 300 to scrape and gather the non-Newtonian fluid contaminant.

In addition, the controller 500 may be configured to selectively operate at least one of the cleaning solution spray device, the vacuum suction device, or the brushing device under conditions in which vehicle is turned off and a passenger exits the vehicle, and a signal satisfying the passenger exit condition may be provided from a seat belt reminder 410 that detects non-use of the seat belt to the controller 500.

Hereinafter, a seat cleaning operation process based on the above-described configuration is described as follows, in accordance with an exemplary embodiment of the present disclosure.

First, under conditions in which the vehicle is turned off and a passenger exits the vehicle, the camera 400 may be configured to capture a contaminant on the seat cover of the vehicle seat and transmit a detection signal to the controller 500.

Subsequently, the controller 500 may be configured to receive the detection signal from the camera 400 that captures a contaminant on the seat cover of the vehicle seat and determines the location and type of the contaminant on the seat cover based on the received contaminant detection signal.

For example, the controller 500 may be configured to determine the location of the contaminant on the seat cover using the set absolute coordinate system as described above, and may be configured to determine a type of contaminant on the seat cover as one of a liquid (milk, juice, coffee, etc.), a non-Newtonian fluid (ketchup, mayonnaise, toothpaste, etc.), or a solid (dirt, salt, sugar, snack crumbs, etc.) based on a contaminant detection signal from the camera 400 and pre-trained data through, e.g., artificial intelligence deep learning image analysis.

Subsequently, the controller 500 may be configured to determine whether the chrominance (ΔE) of the contaminant is greater than or equal to 0.5. If the chrominance (ΔE) of the contaminant is determined to be greater than or equal to 0.5, it may be determined that the contaminant on the seat cover requires cleaning, and the controller 500 may be configured to control the movement of the cleaning tool 300 to the location of the contaminant on the seat cover in order to selectively operate at least one of the cleaning solution spray device 340, the vacuum suction device 350, or the brushing device 360.

Specifically, in response to the control signal from the controller 500, the motor 113 may be driven in one direction, causing the pinion 114 to move forward along the rack gear 112 of the fixed rail 111, thereby moving the storage compartment 100 toward the front of the seat cushion 10. Subsequently, the first motor 201, the second motor 203, and the third motor 205 may be operated to deploy the pivot bar 202, the lower arm 204, and the upper arm 206 of the robot arm 200 toward the location of the contaminant on the seat cover, so that the cleaning tool 300 mounted on the upper arm 206 may reach the location of the contaminant on the seat cover.

Subsequently, at least one of the cleaning solution spray device 340, the vacuum suction device 350, or the brushing device 360 may be selectively operated in response to the control signal from the controller 500.

For example, if the contaminant on the seat cover is determined to be a liquid (milk, juice, coffee, etc.), since the liquid evaporates and leaves a stain, the cleaning solution spray device 340 and brushing device 360 may be operated.

To this end, if the surface of the fixed head 320 of the cleaning tool 300 comes into close contact with the seat cover on which the contaminant is present by the movement of the robot arm 200 in response to a control signal from the controller 500, a pressing force may be applied to the plurality of pressure pins 344, causing the plurality of pressure pins 344 to move rearward, and causing the support plate 343, integrally formed with the pressure pins 344, to compress the spring 345 and move rearward into the cleaning solution reservoir 341.

For example, as described above, one pressure pin 344-1 of the plurality of pressure pins 344 may be positioned to seal the cleaning solution discharge hole 342 and the cleaning solution spray hole 321, and the other pressure pins 344-2 are positioned to open the cleaning solution discharge hole 342 and the cleaning solution spray hole 321, so that the cleaning solution in the cleaning solution reservoir 341 may be discharged toward the contaminant on the seat cover through the opened cleaning solution discharge hole 342 and cleaning solution spray hole 321.

Subsequently, the cleaning tool 300 may be configured to repeatedly move in a left and right direction or a forward and rearward direction by the movement of the robot arm 200 in response to the control signal from the controller 500, so that the towel 363 of the brushing device 360, which is included in the cleaning tool 300, may brush the portion where the cleaning solution is discharged, and accordingly, the contaminant may be wiped and removed by the cleaning solution.

As another example, if the contaminant on the seat cover is determined to be a solid (soil, salt, sugar, snack crumbs, etc.), the vacuum suction device 350 may first be operated, followed by sequential operation of the cleaning solution spray device 340 and the brushing device 360.

To this end, after the cleaning tool 300 reaches the contaminant location on the seat cover by movement of the robot arm 200 in response to the control signal from the controller 500, the vacuum suction fan 355 may be operated in response to the control signal from the controller 500, so that the solid contaminant may be suctioned into the dust container 351 and removed.

Subsequently, in consideration of a stain caused by the solid contaminant remaining on the seat cover, the cleaning solution spray device 340 and the brushing device 360 may be further operated sequentially as described above so that the stain caused by the solid contaminant may be removed.

As a further example, if the contaminant on the seat cover increases in size over a certain period, it may be determined that the contaminant is a certain amount or more of a non-Newtonian fluid (ketchup, mayonnaise, toothpaste, etc.). To prevent the non-Newtonian fluid from spreading, a scraper operation that scrapes and gathers the fluid may be performed first, followed by sequential operation of the vacuum suction device 350, the cleaning solution spray device 340, and the brushing device 360.

To this end, after the cleaning tool 300 reaches the contaminant location on the seat cover by the movement of the robot arm 200 in response to the control signal from the controller 500, a scraper operation, in which the edge portion of the fixed head 320 of the cleaning tool 300 scrapes and gathers the non-Newtonian fluid contaminant, may be performed first as shown, e.g., in FIG. 12.

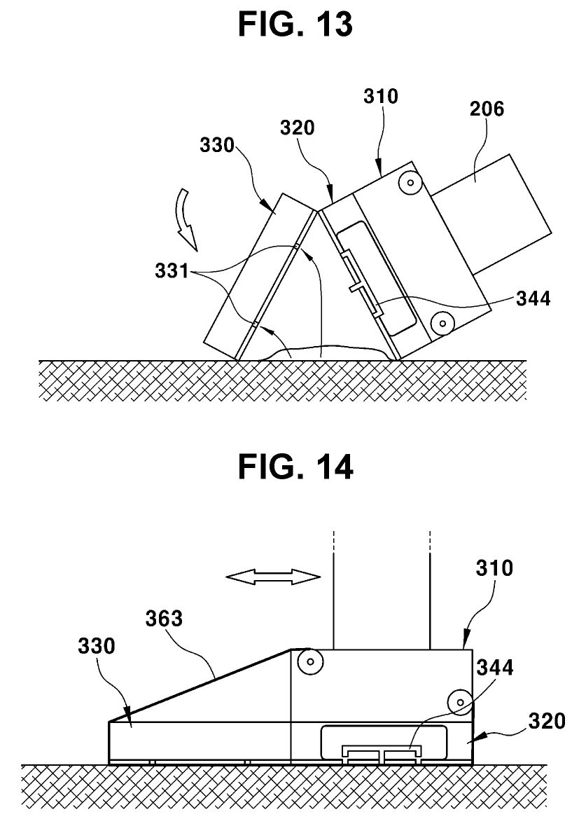

Subsequently, as shown in FIG. 13, the variable head 330 may be configured to fold at a predetermined angle toward the fixed head 320 in response to the control signal from the controller 500 and approach the gathered contaminant, and the vacuum suction fan 355 may be activated, allowing the non-Newtonian fluid contaminant gathered by the scraper operation to be suctioned into the dust container 351 and removed.

Subsequently, as shown in FIG. 14, in consideration of a stain caused by a non-Newtonian fluid contaminant remaining on the seat cover, the cleaning solution spray device 340 and the brushing device 360 may be further operated sequentially as described above so that the stain caused by the non-Newtonian fluid contaminant may be removed.

As such, the camera installed inside the vehicle detects a contaminant on the surface of the seat cover, causing the robot arm to automatically deploy to the contaminant location on the seat cover. Accordingly, the cleaning tool mounted on the front end portion of the robot arm performs a scraper operation, a cleaning solution spraying operation, a cleaning brushing operation, and a vacuum suction operation to automatically remove the contaminant on the seat cover, thereby maintaining the vehicle seat (especially in shared vehicles) in a clean condition at all times.

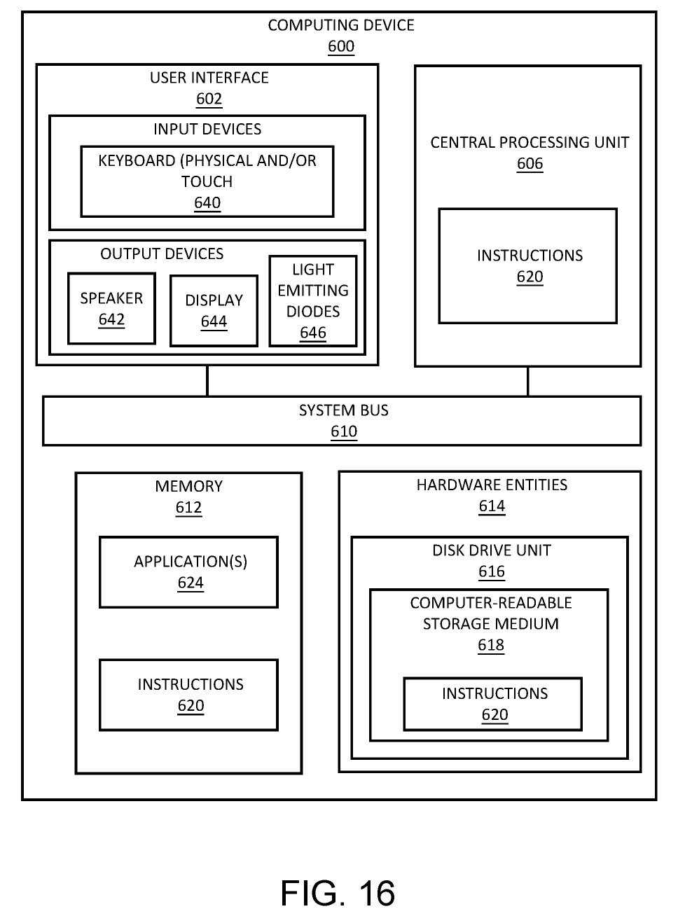

Referring now to FIG. 16, an illustration of an example architecture for a computing device 600 is provided. According to an exemplary embodiment, one or more functions of the present disclosure may be implemented by a computing device such as, e.g., computing device 600 or a computing device similar to computing device 600. Computing device 600 may be a quantum computer, a classical computer, and/or have one or more components configured to perform one or more quantum and/or classical computing functions. Controller 500 may be an example of computing device 600 and/or may comprise one or more components of computing device 600.

The hardware architecture of FIG. 16 represents one example implementation of a representative computing device configured to implement at least a portion of the systems/devices and method(s)/control logic(s) described herein.

Some or all components of the computing device 600 may be implemented as hardware, software, and/or a combination of hardware and software. The hardware may comprise, but is not limited to, one or more electronic circuits. The electronic circuits may comprise, but are not limited to, passive components (e.g., resistors and capacitors) and/or active components (e.g., amplifiers and/or microprocessors). The passive and/or active components may be adapted to, arranged to, and/or programmed to perform one or more of the methodologies, procedures, or functions described herein.

As shown in FIG. 16, the computing device 600 may comprise a user interface 602 (e.g., a graphical user interface), a Central Processing Unit (“CPU”) 606, a system bus 610, a memory 612 connected to and accessible by other portions of computing device 400 through system bus 610, and hardware entities 614 connected to system bus 610. The user interface may comprise input devices and output devices, which may be configured to facilitate user-software interactions for controlling operations of the computing device 600. The input devices may comprise, but are not limited to, a physical and/or touch keyboard 640. The input devices may be connected to the computing device 600 via a wired or wireless connection (e.g., a Bluetooth® connection). The output devices may comprise, but are not limited to, a speaker 642, a display 644, and/or light emitting diodes 646.

At least some of the hardware entities 614 may be configured to perform actions involving access to and use of memory 612, which may be a Random Access Memory (RAM), a disk driver and/or a Compact Disc Read Only Memory (CD-ROM), among other suitable memory types. Hardware entities 614 may comprise a disk drive unit 416 comprising a computer-readable storage medium 618 on which may be stored one or more sets of instructions 620 (e.g., programming instructions such as, but not limited to, software code) configured to implement one or more of the methodologies, procedures, or functions described herein. The instructions 620 may also reside, completely or at least partially, within the memory 612 and/or within the CPU 606 during execution thereof by the computing device 600.

The memory 612 and the CPU 606 may also constitute machine-readable media. The term “machine-readable media”, as used here, refers to a single medium or multiple media (e.g., a centralized or distributed database, and/or associated caches and servers) that store the one or more sets of instructions 620. The term “machine-readable media”, as used here, also refers to any medium that is capable of storing, encoding, or carrying a set of instructions 620 for execution by the computing device 600 and that cause the computing device 600 to perform any one or more of the methodologies of the present disclosure. According to various embodiments, one or more computer applications 624 may be stored on the memory 612.

Although the present disclosure has been described in detail with reference to an embodiment, the scope of the present disclosure is not limited to the embodiment described above. Various modifications and improvements made by those skilled in the art, based on the basic concept of the present disclosure as defined in the claims below, also fall within the scope of the present disclosure.

What is claimed is:

1. A seat cleaning system, comprising:
an image capturing device configured to detect a contaminant on a seat cover;
a controller configured to determine a contaminant location and type of the contaminant on the seat cover based on a contaminant detection signal from the image capturing device;
a robot arm configured to deploy to the contaminant location on the seat cover in response to a control signal from the controller; and
a cleaning tool mounted on a front end portion of the robot arm, the cleaning tool being configured, in response to the control signal, to perform one or more of, on the contaminant:
a scraper operation;
a cleaning solution spraying operation;
a cleaning brushing operation; and
a vacuum suction operation.

2. The seat cleaning system of claim 1, wherein:
the robot arm is stowably mounted in a lower position of the seat cushion frame in a storage compartment configured to move forward and rearward, and
a driving device is mounted between the seat cushion frame and the storage compartment and configured to move the storage compartment forward or rearward.

3. The seat cleaning system of claim 2, wherein the driving device comprises:
fixed rails mounted on both sides of the seat cushion frame;
rack gears formed on upper surfaces of the fixed rails;
a storage compartment motor mounted on a rear portion of the storage compartment, configured to be driven in response to the control signal from the controller; and
a pinion coupled to an output shaft of the motor and engaged with the rack gears to enable forward and rearward movement.

4. The seat cleaning system of claim 1, wherein the robot arm comprises:
a first motor mounted on an inner surface of a storage compartment;
a pivot bar comprising an end portion coupled to an output shaft of the first motor to enable upward and downward rotation;
a second motor mounted on an opposite end portion of the pivot bar;
a lower arm comprising an end portion connected to an output shaft of the second motor to enable left and right rotation;
a third motor mounted on an opposite end portion of the lower arm; and
an upper arm comprising:
an end portion mounted on an output shaft of the third motor to enable upward and downward rotation; and
the cleaning tool mounted on an opposite end portion.

5. The seat cleaning system of claim 4, wherein the cleaning tool comprising:
a main body mounted on an opposite end portion of the upper arm;
a fixed head mounted on an end portion of the main body;
a variable head foldably and unfoldably connected to the fixed head;
a cleaning solution spray device mounted on the fixed head;
a vacuum suction device mounted on the variable head; and
a brushing device mounted on the main body and configured to rotate a towel along surfaces of the fixed head and the variable head.

6. The seat cleaning system of claim 5, further comprising a deployment device mounted on the fixed head and the variable head to be driven in response to the control signal from the controller to fold or unfold the variable head.

7. The seat cleaning system of claim 6, wherein the deployment device comprises:
a variable head rotation motor mounted inside the fixed head and driven in response to the control signal from the controller;
a hinge shaft formed on the variable head and rotatably fastened to the fixed head; and
bevel gears mounted respectively on an output shaft of the variable head rotation motor and the hinge shaft.

8. The seat cleaning system of claim 5, wherein the cleaning solution spray device comprises:
a cleaning solution reservoir installed inside the fixed head;
a support plate positioned inside the cleaning solution reservoir;
a spring mounted inside the cleaning solution reservoir to elastically support the support plate; and
a plurality of pressure pins integrally formed with the support plate and arranged to protrude outward through cleaning solution discharge holes formed in the cleaning solution reservoir and cleaning solution spray holes formed in the fixed head.

9. The seat cleaning system of claim 8, wherein a pressure pin of the plurality of pressure pins is formed longer than the other pressure pins.

10. The seat cleaning system of claim 9, wherein:
in response to a pressing force applied to the plurality of pressure pins, the plurality of pressure pins and the support plate are configured to compress the spring and move toward an inside of the cleaning solution reservoir,
a pressure pin of the plurality of pressure pins is positioned to seal the cleaning solution discharge hole and the cleaning solution spray hole, and
other pressure pins, of the plurality of pressure pins, are positioned to open the cleaning solution discharge hole and the cleaning solution spray hole.

11. The seat cleaning system of claim 8, further comprising a cleaning solution filling cap, arranged to protrude outward through the fixed head, mounted on the cleaning solution reservoir.

12. The seat cleaning system of claim 5, wherein the vacuum suction device comprises:
a dust container mounted inside the variable head;
a suction nozzle formed to extend in four directions from the dust container and fastened to a suction port formed in the variable head;
a vacuum suction fan coupled to the dust container via a connection pipe to provide vacuum suction power; and
a filter installed inside the connection pipe.

13. The seat cleaning system of claim 5, wherein the brushing device comprises:
a winding roller mounted in a first mounting groove formed on a side of the main body;
a collecting roller mounted in a second mounting groove formed on an opposite side of the main body; and
a towel comprising an end portion wound on the winding roller and an opposite end portion connected to the collecting roller, the towel configured to rotate along the surfaces of the fixed head and the variable head.

14. The seat cleaning system of claim 13, wherein the brushing device further comprises:
a driven gear mounted on a rotation shaft of the collecting roller;
a towel rotation motor mounted inside the main body; and
a driving gear mounted on an output shaft of the towel rotation motor and engaged with the driven gear.

15. The seat cleaning system of claim 1, wherein the controller is configured to:
set an absolute coordinate system based on a reference point on an upper portion of a seatback and a reference point on a front portion of a seat cushion captured by the image capturing device, and
determine a location of the contaminant on the seat cover using the set absolute coordinate system.

16. The seat cleaning system of claim 1, wherein the controller is configured to determine the type of contaminant on the seat cover as one of a liquid, a non-Newtonian fluid, or a solid based on the contaminant detection signal from the image capturing device.

17. The seat cleaning system of claim 16, wherein, based on the determined type of contaminant, the controller is configured to:
determine chrominance of the contaminant and size information of the contaminant that changes over a certain period based on the contaminant detection signal transmitted from the image capturing device, and
selectively operate at least one of a cleaning solution spray device, a vacuum suction device, or a brushing device based on the determined chrominance and size information of the contaminant.

18. The seat cleaning system of claim 17, wherein the controller is configured to selectively operate at least one of the cleaning solution spray device, the vacuum suction device, or the brushing device under conditions in which the vehicle is turned off and a passenger exits the vehicle.

19. The seat cleaning system of claim 18, wherein a signal satisfying the passenger exit condition is provided from a seat belt reminder to the controller.

20. A seat cleaning system, comprising:
a computing device comprising a processor and a memory, wherein the memory is configured to store instructions that, when executed by the processor, are configured to cause the processor to:
detect a contaminant on a seat cover, using an image capturing device;
determine a contaminant location and type of the contaminant on the seat cover based on a contaminant detection signal from the image capturing device;
deploy a robot arm to the contaminant location on the seat cover in response to a control signal from a controller; and
using a cleaning tool mounted on a front end portion of the robot arm, in response to the control signal, perform one or more of, on the contaminant:
a scraper operation;
a cleaning solution spraying operation;
a cleaning brushing operation; and
a vacuum suction operation.
